(19) United States
(12) Patent Application Publication
(10) Pub. No.: US 2005/0010875 A1
(43) Pub. Date: Jan. 13, 2005

(54) Multi-focal plane user interface system and method

(76) Inventors: Mark Anthony Darty, Collierville, TN (US); James Douglas Fletcher II, Bartlett, TN (US); Laura Trantham Rhome, Somerville, TN (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/854,132

(22) Filed: May 26, 2004

Related U.S. Application Data
(60) Provisional application No. 60/473,814, filed on May 28, 2003.

(51) Int. Cl. G09G 5/00

(52) U.S. Cl. 715/768; 715/790; 715/791; 715/767; 715/779

(57) ABSTRACT

A method for providing command functionality for a computing device. The method includes the steps of displaying at least one control icon using a first focal plane; and, displaying a working environment using at least a second focal plane distinct from the first focal plane; wherein, the first focal plane appears at least partially superimposed upon the at least second focal plane.

### CROSS REFERENCE TO RELATED APPLICATION

This application claims priority to U.S. Provisional Application No. 60/473,814 filed on May 28, 2003.

### FIELD OF INVENTION

The present invention relates generally to user interface methods and systems, and more particularly to command and control of graphical user interfaces (GUI's).

### BACKGROUND OF THE INVENTION

It has become increasingly desirable to provide increased functionality to users of computing devices, such as personal computers (PC's) including laptop PC's, Personal Digital Assistants (PDA's), cell phones and the like. However, as functionality is added, usability often diminishes. For example, performing command and control type functions often becomes more complicated. For example, to launch an application from a typical graphical user interface operating system, one may need to activate and navigate through several menus to make a desired selection corresponding to a desired function.

This required navigation may be undesirable in certain circumstances where simplified usability is desired, such as where display space and user interface options are limited, such as with a hand-held, portable computing device like a Pocket PC, PDA or cell phone.

### SUMMARY OF THE INVENTION

A method for providing command functionality for a computing device including: displaying at least one control icon using a first focal plane; and, displaying a working environment using at least a second focal plane distinct from the first focal plane; wherein, the first focal plane appears at least partially superimposed upon the at least second focal plane.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and:

FIG. 1 illustrates a system according to an aspect of the present invention;

FIG. 2 illustrates a system according to an aspect of the present invention;

FIG. 3 illustrates a system according to an aspect of the present invention;

FIG. 4 illustrates a system according to an aspect of the present invention; and,

FIG. 5 illustrates a block diagram of a Laser Retinal Display system suitable for use with the present invention.

### DETAILED DESCRIPTION OF THE PREFERRED EMBODIMENTS OF THE INVENTION

It is to be understood that the figures and descriptions of the present invention have been simplified to illustrate elements that are relevant for a clear understanding of the present invention, while eliminating, for purposes of clarity, many other elements found in conventional GUI methods and systems. Those of ordinary skill in the art will recognize that other elements are desirable for implementing the present invention. However, because such elements are well known in the art, and because they do not facilitate a better understanding of the present invention, a discussion of such elements is not provided herein.

Traditionally, information is displayed using a single focal plane. Any perceived sense of depth is attributed to the displayed objects. According to an aspect of the present invention, multiple focal planes may be used to display information on image layers at different perceived distances from the user's eye, creating information planes or layers. According to an aspect of the present invention, different types of information may be displayed on different focal planes. For example, control or command system functionality may be displayed using one or more focal planes, while system applications are displayed using one or more other focal planes. According to an aspect of the present invention, multiple focal planes may also be used in combination with conventional single focal plane techniques such as virtual, three-dimensional intra-plane display and movement elements corresponding to a change of distance from a user.

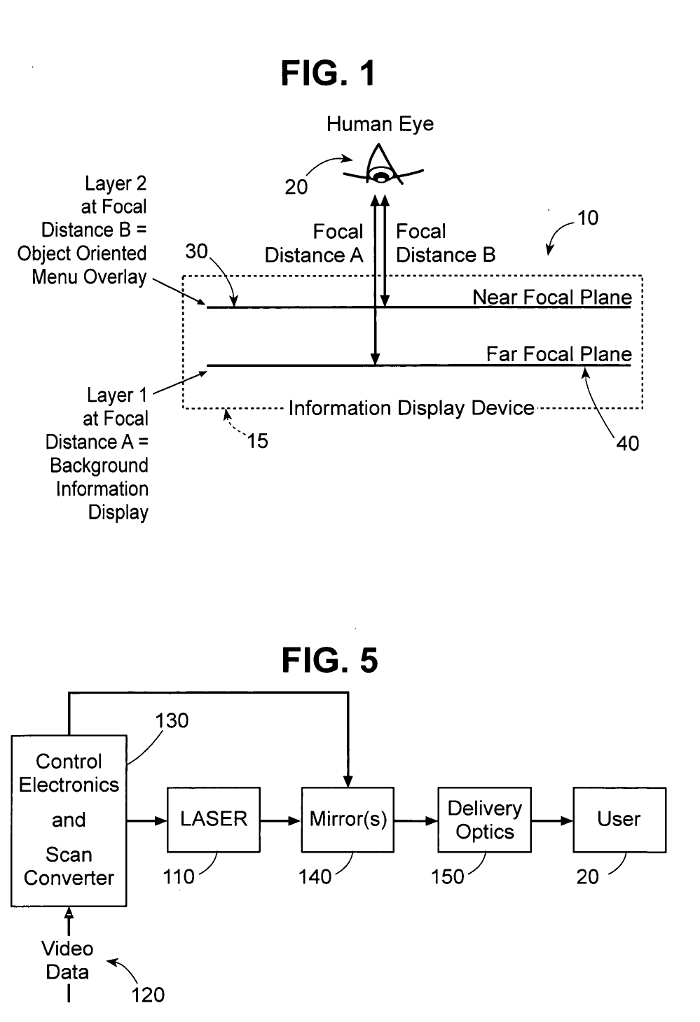

Referring now to FIG. 1, there is shown a system 10 according to an aspect of the present invention. System 10 generally includes an information display device 15. Information display device 15 is suitable for displaying information to a user 20. According to an aspect of the present invention, device 15 may at least partially superimpose multiple, discrete focal planes to display information to user 20. According to an aspect of the present invention, at least two focal planes 30, 40 may be used to display system controls and a working environment to user 20.

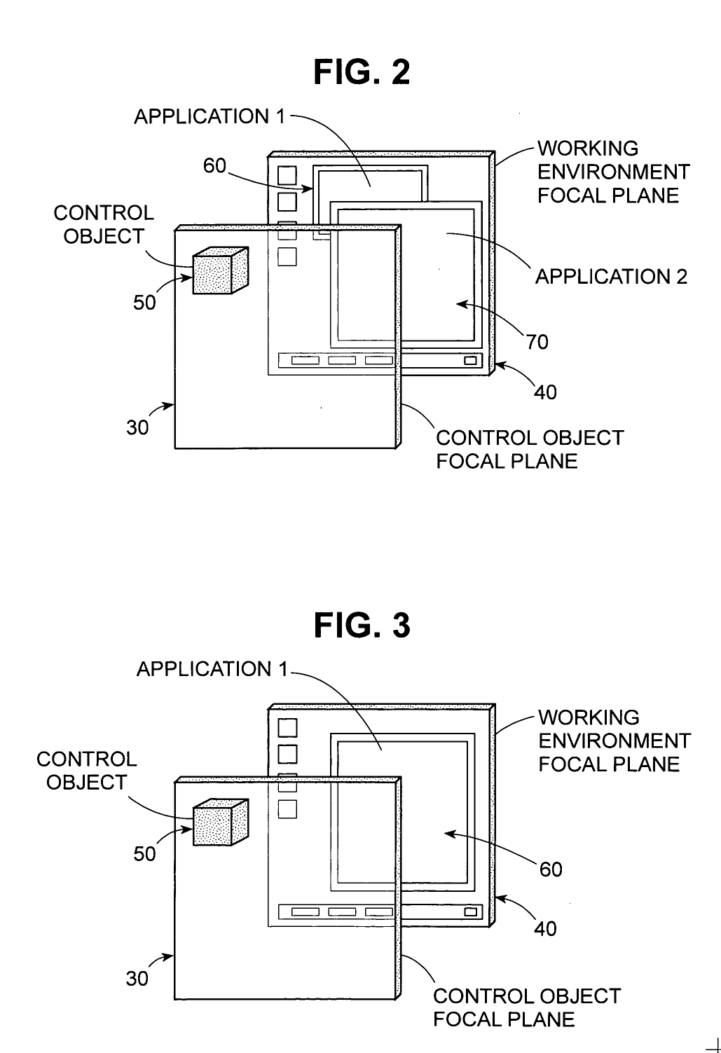

Referring now also to FIGS. 2 and 3, control functionality may be provided on one focal plane, or layer, while the working environment is provided on another. By way of non-limiting example, controls may be presented using focal plane 30, while the working environment is presented using focal plane 40. Controls on layer 30 may be provided using one or more control objects 50, such as user selectable icons. Further, the working environment may include one or more applications 60, 70, as is conventionally understood by one possessing an ordinary skill in the pertinent arts.

For example, one or more control objects 50 may be displayed on a focal plane in the foreground, and take the form of a two, or three-dimensional visual object, such as a cube. Cooperatively, the working environment may be displayed on a focal plane in the background and take the form of one or more conventional applications running in a traditional operating system workspace.

According to an aspect of the present invention, the focal planes, or layers, may be functionally inter-related. For example, a control object 50 may represent a set of logical commands associated with the working environment. By way of non-limiting example only, activation or selection of a control object 50 in a layer 30 may launch an associated application in the working environment displayed using layer 40.

In other words, a control object or primary focal plane may be displayed in the foreground, while a working environment or secondary focal plane is displayed in the background. When a user activates a control object, or selects one or more functions using a control object, an associated applications may be spawned or selected in the working environment focal plane.

For example, and referring still to FIGS. 2 and 3, assuming an application 60 is displayed in a working environment provided via layer 40 (see FIG. 3), activation of a control object 50 provided via control layer 30 (see FIGS. 2 and 3) may cause application 70 to launch within the working environment of layer 40 (see FIG. 2).

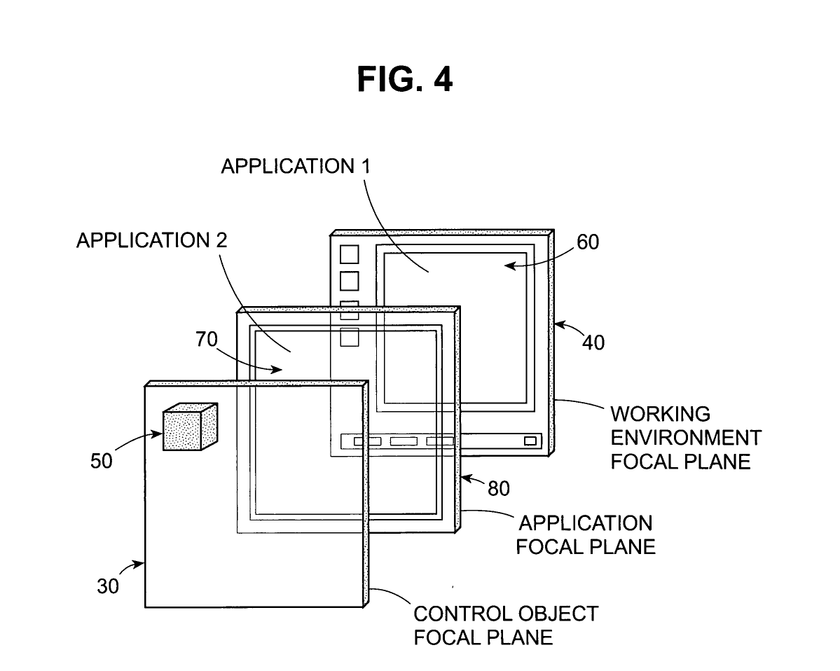

Referring now also to FIG. 4, more than two focal planes may be used to display system control and working environment components. By way of non-limiting example only, control object 50 focal plane 30 may be displayed as a primary focal plane located in the foreground, while the working environment focal plane 40 is displayed as a secondary focal plane located behind it, in the background. As discussed previously, a first application 60 opened or operated by the user may be spawned or selected in the working environment focal plane 40. For example, a user may interact with the control object using a mouse or other input device and the working environment using a keyboard, a mouse or other input device.

When the user opens another application 70, through interaction with the object 50 in plane 30 for example, the new application 70 may be displayed in a new focal plane 80. Focal plane 80 may appear between the control object 50 and primary focal plane 30 and the existing working environment focal plane 40. The control object 50 or primary focal plane 30 may appear in focus and viewable to the user. Further, the new working environment focal plane 80 may become the secondary focal plane and also appear in focus and viewable to the user. That is, with multiple focal planes, the working environment focal plane containing the application with the current system focus may become the secondary focal plane and, as such, would appear in focus or viewable to the user. All other working environment focal planes may be demoted, such as by appearing transparent or blurred, and out of focus to the user, opaque, or translucent, by way of non-limiting example only. This demoting of importance of focal planes other than the primary and secondary focal planes may serve to allow the user to more easily interact with the active working environment without being distracted by information or applications displayed by other focal planes. For example, a primary or secondary focal plane may have a unique color, brightness or contrast associated with it, while other focal planes are demoted as being of limited importance to the user for the moment. When the importance of different focal planes changes, due to user interaction with a command focal plane for example, the visual characteristics of the other planes may be reorganized depending upon user selections.

Further, a focal plane in focus and at least partially superimposed upon another focal plane in focus may appear partially transparent or translucent, and have an opaqueness less than 100%, to facilitate use of the background focused focal plane.

According to an aspect of the present invention, the different focal planes utilized may be displayed using a virtual display device, like a Laser Retinal Display (LRD), or other system capable of displaying multiple focal planes simultaneously, for example.

LRD's (sometimes called Virtual Retinal Displays) are well understood by those possessing an ordinary skill in the pertinent arts. For sake of completeness only, and referring now to FIG. 5, there is shown a non-limiting block-diagram of an LRD system 100 suitable for use with the present invention. In general, a-low power laser 110 is modulated with information 120 to be displayed and then scanned directly onto the retina of user 20.

Information 120 may be provided in the form of a conventional VGA signal. Of course, any suitable method for providing information 120 may be used though. Information 120 may be provided to a conventional laser power modulating control unit 130, for example, which modulates the power of laser 110 responsively thereto. Of course, any suitable method of modulating laser 110 responsively to information 120 may be used though. Laser 110 may output light in the range of 636 nm, for example, and be scanned in the horizontal at around 15.75 kHz and in the vertical at around 60 Hz using mirrors 140. Of course, any suitable operating wavelength and scanning methods or rates may be used though. In fact, it may be desirable to increase the scanning rates to facilitate presentation of multiple focal planes, as will be discussed in more detail below. Delivery optics 150 may converge the scanned beam to an about 0.8 mm image at an exit pupil, which image may be used to impinge upon the retina of user 20. Of course, any method for delivering the scanned image to the retina of a user may be used though.

According to an aspect of the present invention, the scanning rates of mirrors 140 that correspond to each focal plane to be displayed may represent a portion of the overall mirror 140 scanning rate, such as half or one-third, to allow the system 100 to provide multiple image planes. That is, and by way of non-limiting example only, mirrors 140 may scan each of two focal planes at a rate of half of a single scan rate, such as at a rate of 7.875 KHz in the horizontal and 60 Hz in the vertical. If the scanning rates of mirrors 140 are 31.5 KHz in the horizontal, well within the operation limits of microelectromechanical system (MEMS) type reflectors for example, than the scanning rate of each of two focal planes may be about 15.75 KHz in the horizontal and 60 Hz in the vertical, for example. Further, one focal plane (such as a primary focal plane) may be scanned at a rate higher than another focal plane (such as a secondary focal plane). And, the relative scanning rates of individual focal planes may be changed depending upon user interactivity with a focal plane. As is well understood in the pertinent arts, a MEMS is an integrated electrical and mechanical system, that may be used as a miniature actuator for rotating a mirror.

According to an aspect of the present invention, multiple lasers may be used to provide multiple focal planes. For example, a first system may be used to provide light in a first wavelength range, while another provides light in another wavelength range. By way of non-limiting example only, a first laser may output light of about 320 nm-500 nm (roughly blue), while another outputs light of about 500 nm-600 nm (roughly green), while another outputs light of about 600 nm-780 nm (roughly red). The outputs of these laser may be combined to provide color images as is well understood in the pertinent arts. Further, the outputs may be separated, such as by separate scanning or selective modulation corresponding to the scanning, to provide multiple focal planes, where each focal plane may be of a different color, for example.

According to an aspect of the present invention, the different focal planes utilized may be displayed using more conventional display types, such as CRT or LCD type display device, for example. In such a case, chromakey techniques may be used to separate control objects from the working environment.

Chromakey is a phrase used primarily in television and video production almost exclusively. With the chromakey technique, every entity in an image set at a specific color may be keyed out and replaced by either another image or a color from a color generator. The chromakey technique enables an image object to be layered onto another image object in a video data stream. Originally, the chromakey was set to red, green, or blue to correspond with the three independent sensors of a broadcast video camera, although chromakeys can be set to virtually any single specific color value.

Since the chromakey technique may be used to separate information into different focal planes, focal plane division may be configured by the user, based on logical functionality or defined by application grouping.

According to an aspect of the present invention, multiple computer video outputs may be displayed on multiple focal planes or layers of information simultaneously or sequentially through a single Human Interface Device (HID). Each video output may send the HID an individual information object. Each video output may represents a different focal plane or layer. Each information object may consume the entire display space (for example: 640×480 pixels on a VGA sized HID). Where each information object consumes a fraction of the entire display space (for example, ¼ VGA, Quarter VGA (QVGA) or 320×240 pixels on a full VGA sized HID) the remainder of the display space may be represented by a chromakey color (RGB 8-bit value 255:0:0 (RED), 0:255:0 (GREEN), or 0:0:255 (BLUE)), for example. Further, the chromakey color may be removed by the HID to display only the information object.

That is, each information object may consume a fraction of the entire display space (one example being 320×240 pixels on a VGA sized HID) and the remainder of the display space may be represented by a single specific color not used by the information object. The single specific color may be removed to display only the information object.

According to an aspect of the present invention, each video output sent to the HID may represent a specific focal plane or layer and use a communications port, such as, by way of non-limiting example only, a Universal Serial Bus (USB) connection to the HID. This connection may serve to communicate information about one or more objects to be displayed to the HID, such as display boundaries. Where each information object consumes the entire display space (for example: 640×480 pixels on a VGA sized HID), those portions of the different information objects to be focused may be used. Thus, a chromakey color may be removed such that the HID displays only the information object. Further, the remainder of the display may be blurred out. Further, a different information object or layer may be selected to bring into focus, and that information object may be moved to the front for full display, while the remainder of the display space is blurred.

According to an aspect of the present invention, the different focal planes utilized may be displayed using a multi-layer display, such as the DeepVideo 18MxG, which is commercially available from Deep Video Imaging, Inc. of Auckland, New Zealand. Multiple inputs of such a display may be fed using a dual output video card, such as the Matrox G550, which is commercially available from Matrox Graphics, Inc. of Quebec, Canada. Each input may correspond to a focal plane. Images to be displayed on the various focal planes may be created in a conventional manner user Microsoft Visual Studio, which is commercially available from Microsoft Corp. of Redmond, Washington and Java 2 Platform SE, which is commercially available from Sun Microsystems, Inc. of Santa Clara, Calif.

Regardless of what technique is used, a method for system and information navigation control using a computer graphical user interface may be provided, wherein certain controls or groups of controls are represented by icons or objects that reside on an image layer at a different focal distance than the image layer used for general information display or other software applications. Certain image layers may be dedicated to classification or categories of system control. Image layers or objects thereon may be turned on or off by the user so as to prevent visual information overload. A 3-dimensional visual environment may thus be created wherein data and object features are distributed across multiple focal planes, so that when integrated together, objects may appear to move from a location closer to the user to a location farther away. The moving object may be the center of focus for the user, thereby causing the image layers on which the object is located to be in focus and other layers to be out of focus so that the user's attention is drawn primarily to the object in focus as it moves within the display area. This can be accomplished by computer software that transitions the object features sequentially through multiple layers positioned at different perceived focal distances from the user's eye, by way of non-limiting example only.

Those of ordinary skill in the art will recognize that many modifications and variations of the present invention may be implemented without departing from the spirit or scope of the invention. Thus, it is intended that the present invention covers the modifications and variations of this invention provided they come within the scope of the appended claims and their equivalents.

1. A method for providing command functionality for a computing device comprising:
displaying at least one control icon using a first focal plane; and,
displaying a working environment using at least a second focal plane distinct from said first focal plane;
wherein, said first focal plane appears at least partially superimposed upon said at least second focal plane.

2. The method of claim 1, wherein said focal planes are displayed using at least one of a computer monitor and laser retinal display.

3. The method of claim 1, wherein said first focal plane appears at a different distance than said second focal plane.

4. The method of claim 3, wherein said displaying said first and second focal planes comprises simulating objects at different focus distances from a user in a two dimensional environment.

5. The method of claim 3, wherein said focal planes are formed at different focal distances from a user.

6. The method of claim 1, wherein said control icon is responsive to at least one of a mouse, a keyboard, voice activation, and computing input device.

7. The method of claim 1, wherein said first focal plane appears at a first distance from a user, said second focal plane appears at a second distance from said user, and at least one of said first and second distances are at a prescribed focal distance.

8. The method of claim 1, wherein said first focal plane appears at a first distance from a user, said second focal plane appears at a second distance from said user, and at least one of said first and second distances are at a user selectable focal distance.

9. The method of claim 1, positioning of said focal planes corresponds to a prioritization.

10. The method of claim 9, wherein said prioritization is associated with information to be displayed.

11. The method of claim 9, wherein said prioritization is associated with system functionality.

12. The method of claim 1, wherein activation of said icon causes at least one predetermined function in said first focal plane.

13. The method of claim 1, wherein at least one of said focal planes is visually demoted in importance.

14. The method of claim 13, wherein said visual demotion comprises at least one visual characteristic.

15. The method of claim 14, wherein said characteristic comprises blurring.

16. The method of claim 14, wherein said visual characteristic comprises color.

17. A user interface comprising:
a first focal plane displaying at least one control device; and,
at least a second focal plane being distinct from said first focal plane and displaying a working environment;
wherein, said first focal plane appears at least partially superimposed upon said at least second focal plane and user interaction with said at least one control device initiates at least one effect in said working environment.

18. The interface of claim 17, wherein said first focal plane appears at a different distance than said second focal plane.

19. The interface of claim 17, wherein said at least second focal planes comprises second and third focal planes, each displaying a working environment.

20. The interface of claim 19, wherein said first focal plane displays at least two control devices, each respectively associated with one of said working environments.
